(19) United States
(12) Patent Application Publication
(10) Pub. No.: US 2021/0132854 A1
(43) Pub. Date: May 6, 2021

(54) DATA INTERPRETATION APPARATUS, METHOD, AND NON-TRANSITORY TANGIBLE MACHINE-READABLE MEDIUM THEREOF

(71) Applicant: Institute For Information Industry, Taipei (TW)

(72) Inventors: Ping-Heng LI, Taipei (TW); Tzu-Che HUANG, Taipei (TW)

(21) Appl. No.: 16/701,877

(22) Filed: Dec. 3, 2019

(30) Foreign Application Priority Data
Nov. 6, 2019 (TW) 108140290

(51) Int. Cl. G06F 3/06; G06N 3/04; H04L 29/08

(52) U.S. Cl. CPC G06F 3/0653; G06F 3/0604; G16Y 40/10; G06N 3/04; H04L 67/12; G06F 3/0673

(57) ABSTRACT

A data interpretation apparatus, method, and non-transitory tangible machine-readable medium thereof. The data interpretation apparatus includes a storage and a processor, wherein the processor is electrically connected to the storage. The storage stores a plurality of bytes included in a memory of an Internet of Things device. The processor interprets the bytes by a plurality of predetermined interpretation schemes individually and thereby obtains a plurality of interpreted data of each of the predetermined interpretation schemes. Each of the predetermined interpretation schemes is related to a data type and a byte order. The processor analyzes the data characteristic of the plurality of corresponding interpreted data for each of the predetermined interpretation schemes and thereby obtains an analysis result of each of the predetermined interpretation schemes. The processor also determines at least one suggested interpretation scheme from the predetermined interpretation schemes based on the analysis results.

### PRIORITY

This application claims priority to Taiwan Patent Application No. 108140290 filed on Nov. 6, 2019, which is hereby incorporated by reference in its entirety.

### FIELD

The present invention relates to a data interpretation apparatus, method, and non-transitory tangible machine-readable medium thereof. In particular, the present invention relates to a data interpretation apparatus and method, and a non-transitory tangible machine-readable medium thereof for an Internet of Things (IoT) device.

### BACKGROUND

With the rapid development of the science and technology, IoT systems have been widely established in many industries with the hope of collecting and analyzing data by various IoT devices to achieve specific purposes (e.g., to improve the productivity and efficiency of industrial equipments). Currently, IoT devices on the market do not adopt the same format to store the collected data in memories, and the storage format adopted by each IoT device is unknown to users. Therefore, in order to analyze the data collected by the IoT devices to derive accurate analysis results, correctly and quickly interpreting the data in the memories of these IoT devices is an unavoidable issue. The aforementioned demands are more obvious in industrial applications, because Industrial IoT (IIoT) systems involve more diverse IoT devices and may dynamically adjust the configured IoT devices.

Presently, some System Integration (SI) manufacturers have developed special data interpretation systems for specific IoT systems according to requirements of customers. After the data interpretation system has been developed, the data interpretation system has to be modified again by the System Integration manufacturer if the IoT devices included in the IoT system is adjusted. For users, it is quite inconvenient to request the assistance from the System Integration manufacturers repeatedly. Accordingly, a simple and fast data interpretation technology for processing data of tremendous and diverse IoT devices so that users can manage and operate the IoT system by themselves is in an urgent need.

### SUMMARY

Provided is a data interpretation apparatus. The apparatus may comprise a storage and a processor, wherein the processor is electrically connected to the storage. The storage stores a plurality of bytes included in a memory of an IoT device. The processor interprets the bytes by a plurality of predetermined interpretation schemes individually and thereby obtains a plurality of interpreted data of each of the predetermined interpretation schemes, wherein each of the predetermined interpretation schemes is related to a data type and a byte order. The processor further performs a data characteristic analysis on the plurality of corresponding interpreted data for each of the predetermined interpretation schemes and thereby obtains an analysis result of each of the predetermined interpretation schemes. The processor also determines at least one suggested interpretation scheme from the predetermined interpretation schemes based on the analysis results.

Also provided is a data interpretation method, which is adapted for use in an electronic computing apparatus. The electronic computing apparatus stores a plurality of bytes included in a memory of an IoT device. The data interpretation method may comprise the following steps: (a) interpreting the bytes by a plurality of predetermined interpretation schemes individually, and thereby obtaining a plurality of interpreted data of each of the predetermined interpretation schemes, wherein each of the predetermined interpretation schemes is related to a data type and a byte order, (b) performing a data characteristic analysis on the plurality of corresponding interpreted data for each of the predetermined interpretation schemes, and thereby obtaining an analysis result of each of the predetermined interpretation schemes, and (c) determining at least one suggested interpretation scheme from the predetermined interpretation schemes according to the analysis results.

Further provided is a non-transitory tangible machine-readable medium, which stores a computer program comprising a plurality of codes. After the computer program is loaded into an electronic computing apparatus, the electronic computing apparatus executes the codes to perform a data interpretation method. The data interpretation method may comprise: (a) interpreting the bytes by a plurality of predetermined interpretation schemes individually, and thereby obtaining a plurality of interpreted data of each of the predetermined interpretation schemes, wherein each of the predetermined interpretation schemes is related to a data type and a byte order, (b) performing a data characteristic analysis on the plurality of corresponding interpreted data for each of the predetermined interpretation schemes, and thereby obtaining an analysis result of each of the predetermined interpretation schemes, and (c) determining at least one suggested interpretation scheme from the predetermined interpretation schemes according to the analysis results.

The data interpretation technology (at least including the apparatus, the method, and the non-transitory tangible machine-readable medium thereof) forms a plurality of predetermined interpretation schemes according to different data types and different byte orders and then interprets a plurality of bytes included in a memory of an IoT device according to each of the predetermined interpretation schemes individually and, thereby obtains a plurality of interpreted data of each of the predetermined interpretation schemes. The provided technology further perform a data characteristic analysis on the plurality of corresponding interpreted data for each of the predetermined interpretation schemes and thereby obtains an analysis result of each of the predetermined interpretation schemes. At least one suggested interpretation scheme is further determined from the predetermined interpretation schemes according to the analysis results.

In some embodiments, the aforesaid data characteristic analyses may include a periodicity analysis, a continuity analysis, and/or a stability analysis. In these embodiments, the interpreted data of each of the at least one suggested interpretation scheme have at least one of periodicity, continuity, and stability. Moreover, for those embodiments, if there are a plurality of suggested interpretation schemes, the present invention may further determine a priority for each of the suggested interpretation schemes according to a ranking rule. The ranking rule is that the suggested interpretation scheme whose corresponding interpreted data having periodicity is superior to the suggested interpretation scheme whose corresponding interpreted data having continuity and the suggested interpretation scheme whose corresponding interpreted data having continuity is superior to the suggested interpretation scheme whose corresponding interpreted data having stability.

The provided data interpretation technology interprets a plurality of bytes included in a memory of an IoT device by a plurality of predetermined interpretation schemes and provides one or more suggested interpretation schemes based on analysis results of the data characteristic analyses. Therefore, the provided data interpretation technology can easily and quickly complete the data interpretation process of each IoT device in an IoT system and, hence, effectively reduces the difficulty of users' utilization to complete the management and operation of the IoT system by themselves.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a data interpretation apparatus 1 of a first embodiment;

FIG. 1B is a specific example of the bytes included in a memory of an IoT device; and

FIG. 2 is a flowchart depicting a data interpretation method of a second embodiment.

### DETAILED DESCRIPTION

In the following description, a data interpretation apparatus, method, and non-transitory tangible machine-readable medium thereof will be explained with reference to certain example embodiments thereof. However, these example embodiments are not intended to limit the present invention to any specific environment, example, embodiment, applications, or particular implementations described in these example embodiments. Therefore, description of these example embodiments is only for purpose of illustration rather than to limit the present invention.

It should be appreciated that, in the following embodiments and the attached drawings, elements unrelated to the present invention are omitted from depiction; and dimensions of and dimensional scales among individual elements in the attached drawings are provided only for ease of understanding, but not to limit the actual scale.

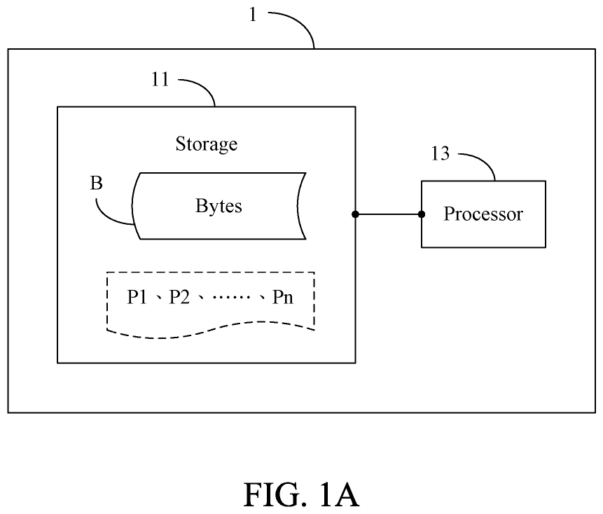

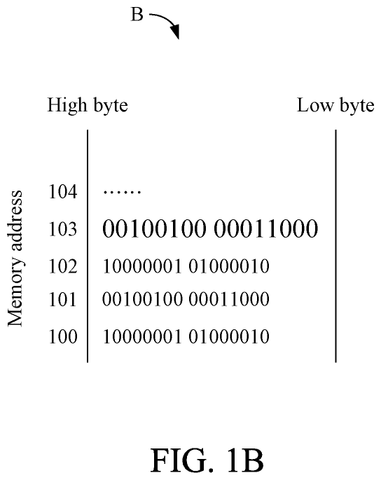

A first embodiment of the present invention is a data interpretation apparatus 1, whose schematic view is depicted in FIG. 1A. The data interpretation apparatus 1 comprises a storage 11 and a processor 13, and the processor 13 is electrically connected to the storage 11. The storage 11 may be a memory, a hard disk drive (HDD), a universal serial bus (USB), a compact disk (CD), or any other non-transitory storage medium or apparatus capable of storing digital data and well-known to those of ordinary skill in the art. The processor 13 may be one of various processors, central processing units (CPUs), microprocessor units (MPUs), digital signal processors (DSPs), or other computing apparatuses known to those of ordinary skill in the art.

The data interpretation apparatus 1 may be used in combination with an IoT system. For the memory of each of the IoT devices in the IoT system, the data interpretation apparatus 1 determines at least one suggested interpretation scheme for the data stored therein. When an IoT system comprises a plurality of IoT devices, the data interpretation apparatus 1 adopts the same approach to provide at least one suggested interpretation scheme for interpreting the data stored in the memory for each IoT device. Therefore, the operations performed by the data interpretation apparatus 1 will be described in detail by taking one IoT device as an example.

In this embodiment, the storage 11 of the data interpretation apparatus 1 stores a plurality of bytes B that has been included in a memory of an IoT device. The number of bytes B stored in the storage 11 is not limited by the present invention. However, in order to derive a more accurate analysis result, it is suggested that the bytes B stored in the storage 11 comprise the bytes stored in the memory of the IoT device during the process of performing a certain task at least twice (e.g., producing at least two blow bottles) by the IoT device. In some embodiments, the data interpretation apparatus 1 may receive, from the IoT device, the bytes B stored in the memory of the IoT device through a transmission interface (not shown) and then store the bytes B in the storage 11.

The processor 13 of the data interpretation apparatus 1 interprets the bytes B by a plurality of predetermined interpretation schemes P1, P2, . . . , Pn individually and thereby obtains a plurality of interpreted data (not shown) of each of the predetermined interpretation schemes P1, P2, . . . , Pn.

Specifically, each of the predetermined interpretation schemes P1, P2, . . . , Pn is related to a data type and a byte order. The data type adopted by a predetermined interpretation scheme may be a 16-bit signed integer (i.e., int16), a 16-bit unsigned integer (i.e., uint16), a 32-bit signed integer (i.e., int32), a 32-bit unsigned integer (i.e., uint32), a floating-point number (i.e., float), or a binary coded decimal (BCD) without being limited thereto. The byte order adopted by a predetermined interpretation scheme involves whether to exchange the read order of a high byte and a low byte and how to exchange the bytes if needed. In this embodiment, the predetermined interpretation schemes P1, P2, . . . , Pn are stored in the storage 11 in advance (for example, in the design format for raw data).

For comprehension, please refer to FIG. 1B for a specific example of a plurality of bytes B stored in the storage 11. It is noted that the specific example is not intended to limit the scope of the present invention. For example, if a predetermined interpretation scheme is related to a 16-bit unsigned integer and does not change the byte order, the processor 13 first interprets the two bytes stored at the memory address 100 (i.e., 10000001 01000001) and then derive a decimal number 33090 (i.e. the interpreted data is the decimal number 33090). The processor 13 then continues to interpret other bytes of the bytes B in sequence according to the memory address. As another example, if a predetermined interpretation scheme is related to a 16-bit signed integer and does not change the byte order, the processor 13 first interprets the two bytes stored at the memory address 100 and then derive a decimal number −32446 (i.e. the interpreted data interpreted is the decimal number −32446). The processor 13 also continues to interpret other bytes of the bytes B in sequence according to the memory address. How other predetermined interpretation schemes interpret the bytes B stored in the storage 11 shall be appreciated by those of ordinary skill in the art, so the details will not be described herein.

Next, for each of the predetermined interpretation schemes P1, P2, . . . , Pn, the processor 13 performs a data characteristic analysis on the corresponding interpreted data and thereby obtaining an analysis result (not shown) of each of the predetermined interpretation schemes P1, P2, . . . , Pn. In some embodiments, the processor 13 may perform a data characteristic analysis on the corresponding interpreted data for each of the predetermined interpretation schemes P1, P2, . . . , Pn by at least one trained neural network model. The aforesaid trained neural network model may be a convolution neural network, a deep neural network, or other neural networks. Thereafter, the processor 13 determines at least one suggested interpretation scheme (not shown) from the predetermined interpretation schemes P1, P2, . . . , Pn according to the analysis results of the predetermined interpretation schemes P1, P2, . . . , Pn.

The present invention provides three kinds of data characteristic analyses. In different embodiments, the processor 13 may adopt one or more of the three kinds of data characteristic analyses. These three kinds of data characteristic analyses will be described in detail hereby.

The first kind of data characteristic analysis is a periodicity analysis. If the periodicity analysis is adopted, the processor 13 analyzes whether the corresponding interpreted data of each of the predetermined interpretation schemes P1, P2, . . . , Pn (i.e., the interpreted data obtained by each of the predetermined interpretation schemes P1, P2, . . . , Pn after interpreting the bytes B) has periodicity. If the interpreted data corresponding to a predetermined interpretation scheme has periodicity, the processor 13 selects the predetermined interpretation scheme as one of the suggested interpretation schemes. Therefore, if the periodicity analysis is adopted, the corresponding interpreted data of each suggested interpretation scheme determined by the processor 13 has periodicity. It is noted that, in some embodiments, the processor 13 may perform the periodicity analysis on the corresponding interpreted data for each of the predetermined interpretation schemes P1, P2, . . . , Pn by a trained neural network model.

The second kind of data characteristic analysis is a continuity analysis. If the continuity analysis is adopted, the processor 13 analyzes whether the corresponding interpreted data of each of the predetermined interpretation schemes P1, P2, . . . , Pn (i.e., the interpreted data obtained by each of the predetermined interpretation schemes P1, P2, . . . , Pn after interpreting the bytes B) has continuity (e.g., increment, decrement, without being limited thereto). If the interpreted data corresponding to a predetermined interpretation scheme has continuity, the processor 13 selects the predetermined interpretation scheme as one of the suggested interpretation schemes. Therefore, if the continuity analysis is adopted, the corresponding interpreted data of each suggested interpretation scheme determined by the processor 13 has continuity. Please noted that, in some embodiments, the processor 13 may perform the continuity analysis on the corresponding interpreted data for each of the predetermined interpretation schemes P1, P2, . . . , Pn by a trained neural network model.

The third kind of data characteristic analysis is a stability analysis. If the stability analysis is adopted, the processor 13 analyzes whether the corresponding interpreted data of each of the predetermined interpretation schemes P1, P2, . . . , Pn (i.e., the interpreted data obtained by each of the predetermined interpretation schemes P1, P2, . . . , Pn after interpreting the bytes B) has stability (i.e., the interpreted data oscillates slightly around a certain value, the interpreted data oscillates within a numerical range). If the interpreted data corresponding to a predetermined interpretation scheme has stability, the processor 13 selects the predetermined interpretation scheme as one of the suggested interpretation schemes. Therefore, if the stability analysis is adopted, the corresponding interpreted data of each suggested interpretation scheme determined by the processor 13 has stability. It is noted that, in some embodiments, the processor 13 may perform the stability analysis on the corresponding interpreted data for each of the predetermined interpretation schemes P1, P2, . . . , Pn via a trained neural network model.

As described above, in different embodiments, the processor 13 of the data interpretation apparatus 1 may select one or more of the three kinds of data characteristic analyses (i.e., periodicity analysis, continuity analysis, and stability analysis). If the processor 13 adopts more than one kind of data characteristic analysis, the processor 13 will select a predetermined interpretation scheme as one of the suggested interpretation schemes as long as the interpreted data corresponding to the predetermined interpretation scheme have at least one of the aforesaid data characteristics. For example, if the processor 13 adopts the above-mentioned three kinds of data characteristic analyses, the processor 13 will select a predetermined interpretation scheme as one of the suggested interpretation schemes as long as the interpreted data corresponding to the predetermined interpretation scheme have at least one of periodicity, continuity, and stability. Therefore, if the above-mentioned three kinds of data characteristic analyses are adopted, the corresponding interpreted data of each suggested interpretation scheme determined by the processor 13 have at least one of periodicity, continuity, and stability.

It is noted that, in some embodiments, the processor 13 may perform the periodicity analysis, continuity analysis, and stability analysis on the corresponding interpreted data of each of the predetermined interpretation schemes P1, P2, . . . , Pn by one or more trained neural network models.

In some embodiments, the processor 13 determines a plurality of suggested interpretation schemes. If the processor 13 adopts more than one kind of data characteristic analysis, the processor 13 determines a priority for each of the suggested interpretation schemes according to a ranking rule. For example, the aforesaid ranking rule may be: the suggested interpretation scheme whose corresponding interpreted data having periodicity is superior to the suggested interpretation scheme whose corresponding interpreted data having continuity, and the suggested interpretation scheme whose corresponding interpreted data having continuity is superior to the suggested interpretation scheme whose corresponding interpreted data having stability.

According to the above description, the data interpretation apparatus 1 interprets a plurality of bytes B included in the memory of the IoT device individually according to the predetermined interpretation schemes P1, P2, . . . , Pn and thereby obtains a plurality of corresponding interpreted data of each of the predetermined interpretation schemes P1, P2, . . . , Pn. Thereafter, the data interpretation apparatus 1 performs a data characteristic analysis (at least one of a periodicity analysis, a continuity analysis, and a stability analysis) on the corresponding interpreted data for each of the predetermined interpretation schemes P1, P2, . . . , Pn and thereby obtains an analysis result of each of the predetermined interpretation schemes P1, P2, . . . , Pn. The data interpretation apparatus 1 then determines at least one suggested interpretation scheme from the predetermined interpretation schemes P1, P2, . . . , Pn according to the analysis results.

If the data interpretation apparatus 1 determines a plurality of suggested interpretation schemes, the data interpretation apparatus 1 may further determine a priority for each of the suggested interpretation schemes according to a ranking rule. The ranking rule is that the suggested interpretation scheme whose corresponding interpreted data having periodicity is superior to the suggested interpretation scheme whose corresponding interpreted data having continuity and the suggested interpretation scheme whose corresponding interpreted data having continuity is superior to the suggested interpretation scheme whose corresponding interpreted data having stability. Through the aforesaid operations, the data interpretation apparatus 1 can easily and quickly complete the data interpretation process of each IoT device in an IoT system and, hence, effectively reduces the difficulty of users' utilization to complete the management and operation of the IoT system by themselves.

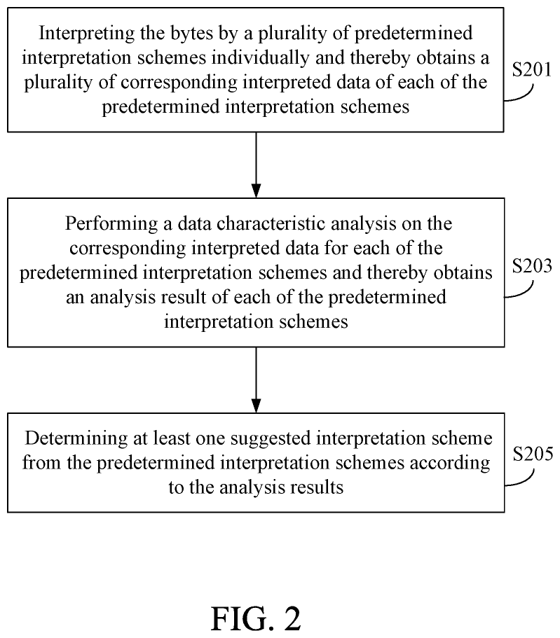

A second embodiment of the present invention is a data interpretation method, and a main flowchart thereof is depicted in FIG. 2. The data interpretation method is adapted for use in an electronic computing apparatus (e.g., the data interpretation apparatus 1 in the first embodiment). The electronic computing apparatus stores a plurality of bytes included in a memory of an IoT device. In order to make the subsequent analysis result more accurate, it is suggested that the bytes stored in the electronic computing apparatus comprise the bytes stored in the memory of the IoT device during the process of performing a certain task at least twice (e.g., producing at least two blow bottles) by the IoT device.

In this embodiment, the data interpretation method executes the process flow shown in FIG. 2. In step S201, the electronic computing apparatus interprets the bytes by a plurality of predetermined interpretation schemes individually and thereby obtains a plurality of corresponding interpreted data of each of the predetermined interpretation schemes, wherein each of the predetermined interpretation schemes is related to a data type and a byte order. Next, in step S203, the electronic computing apparatus performs a data characteristic analysis on the corresponding interpreted data for each of the predetermined interpretation schemes and thereby obtains an analysis result of each of the predetermined interpretation schemes. Thereafter, in step S205, the electronic computing apparatus determines at least one suggested interpretation scheme from the predetermined interpretation schemes according to the analysis results.

In some embodiments, in the step S203, the electronic computing apparatus may perform the data characteristic analysis on the corresponding interpreted data for each of the predetermined interpretation schemes by at least one trained neural network model. The trained neural network model described above may be a convolution neural network, a deep neural network, or other neural networks.

In addition, for the corresponding interpreted data of each of the predetermined interpretation schemes, the present invention provides three kinds of data characteristic analyses. In different embodiments, the step S203 may adopt one or more of the three kinds of data characteristic analyses.

In some embodiments, the aforesaid step S203 is executed by the electronic computing apparatus for performing a periodicity analysis on the corresponding interpreted data for each of the predetermined interpretation schemes (i.e. analyzing whether the corresponding interpreted data of each of the predetermined interpretation schemes has periodicity). If the interpreted data corresponding to a predetermined interpretation scheme has periodicity, the step S205 selects the predetermined interpretation scheme as one of the suggested interpretation schemes. Therefore, if the periodicity analysis is adopted, the corresponding interpreted data of each suggested interpretation scheme selected in the step S205 have periodicity.

In some embodiments, the aforesaid step S203 is executed by the electronic computing apparatus for performing a continuity analysis on the corresponding interpreted data of each of the predetermined interpretation schemes (i.e. analyzing whether the corresponding interpreted data of each of the predetermined interpretation schemes has continuity). If the interpreted data corresponding to a predetermined interpretation scheme has continuity, the step S205 selects the predetermined interpretation scheme as one of the suggested interpretation schemes. Therefore, if the continuity analysis is adopted, the corresponding interpreted data of each suggested interpretation scheme selected in the step S205 have continuity.

In some embodiments, the aforesaid step S203 is executed by the electronic computing apparatus for performing a stability analysis on the corresponding interpreted data for each of the predetermined interpretation schemes (i.e. analyzing whether the corresponding interpreted data of each of the predetermined interpretation schemes has stability). If the interpreted data corresponding to a predetermined interpretation scheme has stability, the step S205 selects the predetermined interpretation scheme as one of the suggested interpretation schemes. Therefore, if the stability analysis is adopted, the corresponding interpreted data of each suggested interpretation scheme selected in the step S205 have stability.

In some embodiments, the aforesaid step S203 may select one or more of the three kinds of data characteristic analyses (i.e., periodicity analysis, continuity analysis, and stability analysis). If the step S203 adopts more than one kind of data characteristic analysis, a predetermined interpretation scheme will be selected as one of the suggested interpretation schemes in the step S205 as long as the corresponding interpreted data of that predetermined interpretation scheme have at least one of periodicity, continuity, and stability. If the step S203 adopts the above-mentioned three kinds of data characteristic analyses, the corresponding interpreted data of each suggested interpretation scheme selected in the step S205 have at least one of periodicity, continuity, and stability.

In some embodiments, the step S205 will determine a plurality of suggested interpretation schemes. In these embodiments, if the step S203 adopts more than one kind of data characteristic analysis, the data interpretation method may further execute a step (not shown) to determine a priority for each of the suggested interpretation schemes by the electronic computing apparatus according to a ranking rule. For example, the ranking rule may be: the suggested interpretation scheme whose corresponding interpreted data having periodicity is superior to the suggested interpretation scheme whose corresponding interpreted data having continuity, and the suggested interpretation scheme whose corresponding interpreted data having continuity is superior to the suggested interpretation scheme whose corresponding interpreted data having stability.

In addition to the aforesaid steps, the second embodiment can also execute all the operations and steps set forth in the first embodiment, have the same functions, and deliver the same technical effects as the first embodiment. How the second embodiment executes these operations and steps, has the same functions, and delivers the same technical effects as the first embodiment will be readily appreciated by those of ordinary skill in the art based on the explanation of the first embodiment, so the details are not given herein.

The data interpretation method described in the second embodiment may be implemented as a computer program comprising a plurality of codes. The computer program is stored in a non-transitory tangible machine-readable medium. The non-transitory computer readable storage medium may be an electronic product, e.g., a read only memory (ROM), a flash memory, a hard disk, a compact disk (CD), a digital versatile disc (DVD), a mobile disk, or any other storage medium with the same function and well-known to those of ordinary skill in the art. After the codes of the computer program are loaded into an electronic computing apparatus (e.g., the data interpretation apparatus 1), the electronic computing apparatus executing executes the data interpretation method as described in the second embodiment.

According to the above descriptions, the data interpretation technology (at least including the apparatus, the method, and the non-transitory tangible machine-readable medium thereof) provided by the present invention interprets a plurality of bytes included in a memory of an IoT device individually according to a plurality of predetermined interpretation schemes and thereby obtains a plurality of corresponding interpreted data of each of the predetermined interpretation schemes. The data interpretation technology provided by the present invention further performs a data characteristic analysis (at least one of periodicity analysis, continuity analysis, and stability analysis) on the corresponding interpreted data for each of the predetermined interpretation schemes and thereby obtains an analysis result of each of the predetermined interpretation schemes. Thereafter, the data interpretation technology provided by the present invention further determines at least one suggested interpretation scheme from the predetermined interpretation schemes according to the analysis results.

If several suggested interpretation schemes are determined, the data interpretation technology provided by the present invention may further determine a priority for each of the suggested interpretation schemes according to a ranking rule. The ranking rule is that the suggested interpretation scheme whose corresponding interpreted data having periodicity is superior to the suggested interpretation scheme whose corresponding interpreted data having continuity and the suggested interpretation scheme whose corresponding interpreted data having continuity is superior to the suggested interpretation scheme whose corresponding interpreted data having stability. Therefore, the data interpretation technology provided by the present invention can easily and quickly complete the data interpretation process of each IoT device in an IoT system and, hence, effectively reduces the difficulty of users' utilization to complete the management and operation of the IoT system by themselves.

The above disclosure is only utilized to enumerate some embodiments of the present invention and illustrated technical features thereof, which is not used to limit the scope of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data interpretation apparatus, comprising:
a storage, being configured to store a plurality of bytes included in a memory of an Internet of Things (IoT) device; and
a processor, being electrically connected to the storage and configured to interpret the bytes by a plurality of predetermined interpretation schemes individually and thereby obtain a plurality of interpreted data of each of the predetermined interpretation schemes, wherein each of the predetermined interpretation schemes is related to a data type and a byte order,
wherein the processor further performs a data characteristic analysis on the plurality of corresponding interpreted data for each of the predetermined interpretation schemes and thereby obtains an analysis result of each of the predetermined interpretation schemes, and the processor further determines at least one suggested interpretation scheme from the predetermined interpretation schemes based on the analysis results.

2. The data interpretation apparatus of claim 1, wherein each of the data characteristic analyses is a periodicity analysis, and the interpreted data of each of the at least one suggested interpretation scheme have periodicity.

3. The data interpretation apparatus of claim 1, wherein each of the data characteristic analyses is a continuity analysis, and the interpreted data of each of the at least one suggested interpretation scheme have continuity.

4. The data interpretation apparatus of claim 1, wherein each of the data characteristic analyses is a stability analysis, and the interpreted data of each of the at least one suggested interpretation scheme have stability.

5. The data interpretation apparatus of claim 1, wherein each of the data characteristic analyses comprises a periodicity analysis, a continuity analysis, and a stability analysis, and the interpreted data of each of the at least one suggested interpretation scheme have at least one of periodicity, continuity, and stability.

6. The data interpretation apparatus of claim 5, wherein the processor determines a plurality of suggested interpretation schemes, and the processor further determines a priority for each of the suggested interpretation schemes according to a ranking rule, wherein the ranking rule is that the suggested interpretation scheme whose corresponding interpreted data having periodicity is superior to the suggested interpretation scheme whose corresponding interpreted data having continuity and the suggested interpretation scheme whose corresponding interpreted data having continuity is superior to the suggested interpretation scheme whose corresponding interpreted data having stability.

7. The data interpretation apparatus of claim 1, wherein the processor performs the data characteristic analyses by a neural network model.

8. A data interpretation method, being adapted for use in an electronic computing apparatus, the electronic computing apparatus storing a plurality of bytes included in a memory of an IoT device, the data interpretation method comprising:
(a) interpreting the bytes by a plurality of predetermined interpretation schemes individually, and thereby obtaining a plurality of interpreted data of each of the predetermined interpretation schemes, wherein each of the predetermined interpretation schemes is related to a data type and a byte order;
(b) performing a data characteristic analysis on the plurality of corresponding interpreted data for each of the predetermined interpretation schemes, and thereby obtaining an analysis result of each of the predetermined interpretation schemes; and
(c) determining at least one suggested interpretation scheme from the predetermined interpretation schemes according to the analysis results.

9. The data interpretation method of claim 8, wherein each of the data characteristic analyses is a periodicity analysis, and the interpreted data of each of the at least one suggested interpretation scheme have periodicity.

10. The data interpretation method of claim 8, wherein each of the data characteristic analyses is a continuity analysis, and the interpreted data of each of the at least one suggested interpretation scheme have continuity.

11. The data interpretation method of claim 8, wherein each of the data characteristic analyses is a stability analysis, and the interpreted data of each of the at least one suggested interpretation scheme have stability.

12. The data interpretation method of claim 8, wherein each of the data characteristic analyses comprises a periodicity analysis, a continuity analysis, and a stability analysis, and the interpreted data of each of the at least one suggested interpretation scheme have at least one of periodicity, continuity, and stability.

13. The data interpretation method of claim 8, wherein the step (b) performs the data characteristic analysis on the interpreted data of each of the predetermined interpretation schemes by a neural network model.

14. The data interpretation method of claim 12, wherein the step (c) determine a plurality of suggested interpretation schemes, and the data interpretation method further comprises:
determining a priority for each of the suggested interpretation schemes according to a ranking rule, wherein the ranking rule is that the suggested interpretation scheme whose corresponding interpreted data having periodicity is superior to the suggested interpretation scheme whose corresponding interpreted data having continuity and the suggested interpretation scheme whose corresponding interpreted data having continuity is superior to the suggested interpretation scheme whose corresponding interpreted data having stability.

15. A non-transitory tangible machine-readable medium storing a computer program comprising a plurality of codes, an electronic computing apparatus executing the codes to perform a data interpretation method after the computer program being loaded into the electronic computing apparatus, the electronic computing apparatus storing a plurality of bytes included in a memory of an IoT device, the data interpretation method comprising:
interpreting the bytes by a plurality of predetermined interpretation schemes individually, and thereby obtaining a plurality of interpreted data for each of the predetermined interpretation schemes, wherein each of the predetermined interpretation schemes is related to a data type and a byte order;
performing a data characteristic analysis on the plurality of corresponding interpreted data for each of the predetermined interpretation schemes, and thereby obtaining an analysis result of each of the predetermined interpretation schemes; and
determining at least one suggested interpretation scheme from the predetermined interpretation schemes according to the analysis results.
